(19) United States
(12) Patent Application Publication
(10) Pub. No.: US 2010/0189980 A1
(43) Pub. Date: Jul. 29, 2010

(54) SHEET-LIKE COMPOSITE

(75) Inventors: Jens Glittenberg, Koln (DE); Holger Wermers, Aachen (DE)

Correspondence Address: L James Ristas;ALIX YALE & RISTAS, 750 Main Street, Suite 1400, Hartford, CT, 06103-2721, US

(73) Assignee: ANDREAS KUFFERATH GMBH & CO. KG, Dueren (DE)

(21) Appl. No.: 12/452,297

(22) PCT Filed: Jun. 25, 2007
(86) PCT No.: PCT/EP2007/005570

§ 371 Date: Apr. 2, 2010

(51) Int. Cl. B32B 5/00; D03D 15/00

(52) U.S. Cl. 428/220; 442/181; 442/229; 442/195; 442/189

(57) ABSTRACT

The invention relates to a sheet-like composite (10) comprising at least two groups of elements (12, 14) which each have a greater span in their longitudinal direction (22, 24) than in a direction extending transversely to the longitudinal direction (24, 22), wherein the elements (12) of a first group are flexurally rigid and are arranged with their longitudinal direction (22) extending obliquely, and in particular transversely, to the longitudinal direction (24) of the elements (14) of a second group, and wherein at least some of the elements (12) of the first group have a wooden surface constituting a non-metallic surface, characterized in that the sheet-like composition (10) is embodied as a fabric, in that the elements (12) of the first group form the weft of the sheet-like composite (10), and in that the elements (14) of the second group form the warp of said composite.

The invention relates to a sheet-like composite material comprising at least two groups of stretched out elements connected to one another in a regular arrangement. Such composite materials are used in a multitude of different ways in engineering, for example as wall cladding for interiors and exteriors, as façade décor, as sound protection or visual protection, or also as security screens.

Normally this type of composite material is made by weaving metallic warp and weft threads. Use of metallic warp and, in particular, metallic weft threads is considered necessary here to achieve the required strength and stability. On the other hand, this also results in the characteristic visual appearance of metallic materials, which does not meet all functional and/or aesthetic demands.

A wall element is known from DE 84 01 135 U1, where a number of boards arranged with their narrow sides running in longitudinal direction adjoining one another are connected to one another by flexible strips attached to their rear surface and pointing vertically to the narrow sides. In one embodiment, the flexible strips are glued firmly to the wood and act as hinges.

A metal strip for interior decoration with a wooden covering made of sawdust firmly adhering to it is known from DE 849 302 C. In this way, the metal strip with sawdust covering can be connected to a wooden strip using ordinary joiner's glue in the solution known so that the metal strip adheres indirectly to the wooden strip in this way.

The invention is thus based on the task of providing a sheet-like composite material of the generic type that eliminates the disadvantages of the state of the art. In particular, the composite material according to the invention should meet exacting functional and aesthetic requirements, providing high strength, for example, as well as having an attractive appearance. The composite material should be suitable for many different uses and also meet the given safety requirements.

These requirements are met by the sheet-like composite material defined in claim 1. Special embodiments of the invention are defined in the sub-claims.

In an exemplary embodiment, a particularly pleasant aesthetic impression is created by the non-metallic surface. This opens up new fields of application for the composite material according to the invention as an architectural style feature that can be used to create a warm comfortable atmosphere, while retaining the functionality of the sheet-like composite material. Depending on the physical form of the non-metallic surface, the composite material can be used either indoors or outdoors.

In an exemplary embodiment, glare from light reflection is avoided by using a non-metallic surface. In addition, any undesirable electric conductivity is avoided by using a non-metallic surface. In an exemplary embodiment, the non-metallic surface is designed in such a way, for example by having a surface structure or texture that is not visible or not essentially visible, that particularly good sound absorption is obtained, thus achieving particularly good sound-absorbing properties in the composite material. A typical application field for the sheet-like composite material is architecture, particularly as a room divider or cladding element, where the flexurally rigid elements from the first group are used preferably as weft element.

Due to the non-metallic surface, many different colors, especially colors that appear particularly natural, can be used for the elements of the first group, especially also with surfaces having a matt appearance and which reflect diffuse light.

In an embodiment, at least two elements with a non-metallic surface are arranged beside one another, preferably with the majority of the elements or all elements in the first group having a non-metallic surface. Further elements in the first group can have a metallic surface, at least in some sections. In an exemplary embodiment, elements of the second group can be attached to the metallic surface. In an exemplary embodiment, the elements of the first group, particularly those close to the edge or those at the outer edges, have a metallic surface, or there are at least two elements of the first group with a non-metallic surface arranged in any case between two elements of the first group with a metallic surface.

In an exemplary embodiment, at least some of the elements of the first group are made of a material containing wood fibers. Here, the elements may only have wood fibers on the surface or they may be homogenous and consist of a material containing wood fibers, for example a composite material with wood fiber content. In order to achieve the desired aesthetic appearance in particular, it may suffice to apply wood veneer to a base material. The base structure can also be hollow in this case, especially in order to save on weight.

In an exemplary embodiment, the elements of the first group consist, at least partly, of wooden slats, where the type and color of the wood can be adapted to suit the strength, weight, acoustic, and other requirements. As an alternative or in addition to elements of the first group containing wood fibers, these elements can also be made of fiber-reinforced plastics, for example glass or carbon fiber reinforced plastics, hollow tubes made of plastic or metal, or of flexurally rigid paper yarn body material.

In an exemplary embodiment, the elements of the first group have a polygonal outer contour, for example an equilateral triangle, square, rectangle, or polygon, and so on. The cross-sectional contour of the elements of the first group here may be congruent, uniform but enlarged or reduced in size, or alternating, depending on the application. For example, as an alternative or in addition to elements with a polygonal outer contour, it is possible to use elements whose outer contour is round, oval, and so forth. The outer contour of an element of the first group can also be polygonal in sections, and in other sections it can have round or oval curves. The outer contour can also vary along the length of the elements, particularly in the area where it intersects with the elements of the second group, and/or deviate at the edge from the contour of the sections in between.

In order to meet the requirements relating to strength, visual and acoustic properties, the span of the elements of the first group transversely to the longitudinal direction is between 2 and 100 mm, preferably between 10 and 50 mm, in an exemplary embodiment. The clear width between two neighboring elements of the first group amounts to at least 10% of the span of the elements in the corresponding direction. In an exemplary embodiment, the spacing between two neighboring elements of the first group is between 5 and 1,000 mm, where the spacing is to be understood as the grid dimension for the elements of the first group. The corresponding grid dimension for the elements of the second group is between 3 and 500 mm.

In an exemplary embodiment, the span of the elements of the second group transversely to their longitudinal direction is between 0.5 and 10 mm. The clear width between two neighboring elements of the first and/or second group can be varied here in such a way that a pre-selectable visual or haptic effect is achieved in the composite material. For this purpose it would also be possible to use elements of the first and/or second group, for example, whose apparent color differs from one element to the next or even changes over the length of an element. If necessary, this coloring can also be created by dyeing, particularly by painting the elements accordingly before manufacturing the composite material, or the composite material can be designed in color accordingly after manufacture.

By varying the spacing between the elements of the first and/or second group, a pre-defined frequency sensitivity of the sound-proofing or sound-absorption properties of the composite material can also be provided. For this purpose both the geometric dimensions of the elements and their spacing can be calculated in advance by simulating with finite elements, depending on the material used for the first and second elements, and the optimized parameters can then be obtained by combining and, in particular, interweaving the elements of the first and second group accordingly.

In an exemplary embodiment, at least some of the elements of the second group are flexurally pliable. This also includes elements that essentially can only transmit tensile forces, such as monofilament or multifilament threads or cords. Since the composite material is manufactured as a fabric, the elements of the second group form the warp of this fabric. Using a monofilament meets special aesthetic demands, while also providing high strength. Use of a multifilament, for example a cord, thread or yarn, enables the use of highly flexible second elements. For example, it is possible to use plastic or metal monofilaments, plastic or metal cords, or cords made of natural fibers.

One or more warp cords can be used, and different materials can also be used for the elements of the second group. Elements of the second group close to or at the edges, for example, can be made of a metallic material, while elements of the second group in the interior of the composite material can be made of a non-metallic material. Suitable metallic materials for the elements of the second group are, in particular, steel, brass or bronze, preferably also stainless steel, and, in special applications, also light alloys, such as aluminum or magnesium, or alloys thereof that normally have or form a particularly corrosion-protected surface when exposed to the atmosphere.

In particular, the invention also relates to a sheet-like composite material comprising at least two groups of elements that have a greater span in their longitudinal direction than in a direction extending transversely to the longitudinal direction, where the elements of a first group are flexurally rigid and are arranged with their longitudinal direction extending obliquely and, in particular, transversely to the longitudinal direction of the elements of a second group, and where at least some of the elements of the first group have a non-metallic surface.

In an embodiment the elements of the first group are shaped in such a way that the elements of the second group may have a kink in a section close to or beside the elements of the first group, for example as a result of plastic deformation during weaving. For this purpose the elements of the first group may have a round cross-section or a straight edge in the area where the elements of the first group rest against the elements of the second group. The elements of the first group may consist of wooden spars, for example, with a diameter of 3 to 15 mm, preferably 6 to 10 mm, and the elements of the second group can consist of a stainless steel cord.

Further advantages, characteristic features and details of the invention result from the sub-claims and the following description, where several exemplary embodiments are described in detail and referring to the drawings. Here the features mentioned in the claims and the description can each be essential to the invention individually or in any combination.

FIG. 1 shows a top view of an initial embodiment of the sheet-like composite material,

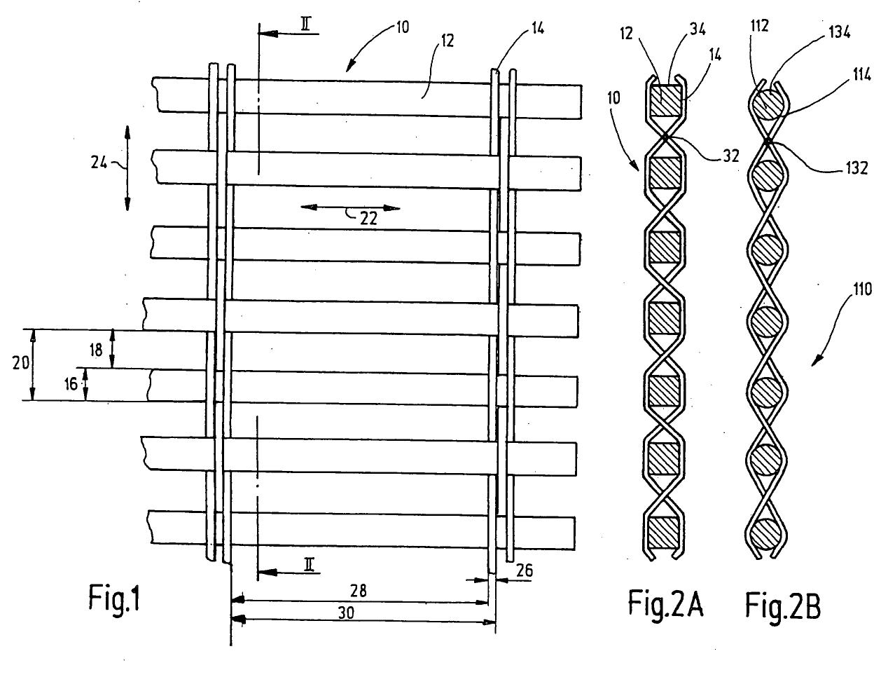

FIG. 2A shows a cross-section of the sheet-like composite material according to FIG. 1 through the line marked II-II,

FIG. 2B shows a cross-section of a further embodiment of the sheet-like composite material,

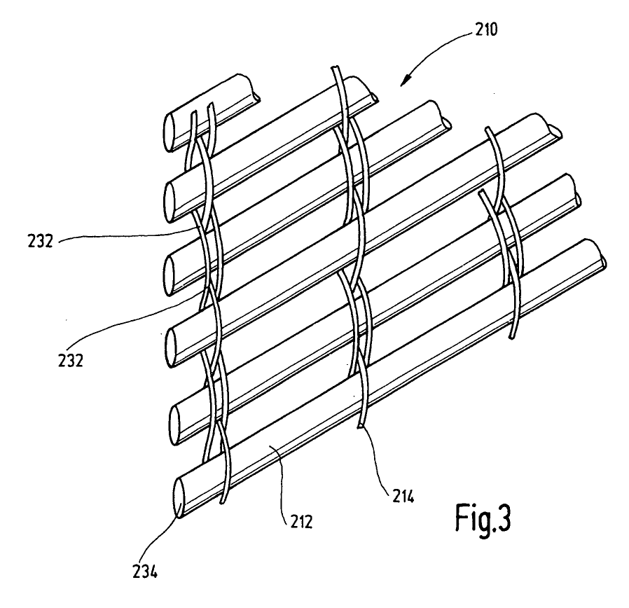

FIG. 3 shows a perspective view of a further embodiment of the sheet-like composite material.

FIG. 1 shows a top view of an initial embodiment of the sheet-like composite material 10, with elements 12 of a first group extending in their longitudinal direction 22 and elements 14 of a second group extending longitudinally in their longitudinal direction 24. Here, the elements 12, 14 have a larger span in their respective longitudinal directions 22, 24 than in the respective transverse direction 24, 22, thereto in each case. Directions 22 and 24 run at right angles to one another in the area formed by the composite material 10. The structure and thus, the properties of the composite material 10 are influenced essentially by the material and dimensions, as well as by the arrangement of the elements 12 of the first group and the elements 14 of the second group. In the embodiment shown in FIG. 1, the elements 12 of the first group and the elements 14 of the second group run parallel to one another, and neighboring elements 12, 14 of the respective groups are disposed, at least partially, at a distance to one another.

The elements 12 of the first group are flexurally rigid and have a clear width 18 to one another, as well as having a span 16 in direction 24, which results in spacing 20 of the elements 12 of the first group if the elements 12 are arranged at regular intervals in relation to the direction 24. The elements 12 of the first group can also be referred to as weft elements in the arrangement provided here. The spacing 20 mentioned can also be considered a grid in direction 24 that describes the arrangement of the elements 12 longitudinally in direction 24 if these elements 12 are arranged at regular intervals. Similarly, a grid or spacing 30 determining the arrangement of the elements 14 of the second group along direction 22 results for the elements 14 or the second group running in direction 24 from their span 26 in their transverse direction and from the clear width 28 between neighboring elements 14 of the second group.

As FIG. 1 already shows, however, the clear width 28 between two elements 14 of this group and the spacing 30 between two elements 14 of this group, which in turn can also be considered here as a grid, can be varied, particularly at elements 14 of the second group. With the embodiment selected, in particular, groups of three elements 14 of the second group are arranged close to one another, where FIG. 1 shows two such arrangements, resulting in a variation of the clear width 28 and the spacing 30 between the elements 14 of the second group. For a larger section of a sheet-like composite material than shown in FIG. 1, however, a regular structure of the entire sheet-like composite material 10 is obtained by adding several sections as shown in FIG. 1, also in direction 22.

In the composite material 10 shown in FIG. 1, where the elements of the first group 12 are formed by a flexurally rigid material, a flexurally or elastically pliable, flexible material is used for the elements 14 of the second group. Using the terms “weft” and “warp” customary in weaving technology, the elements 12 of the first group form the weft, while the elements 14 of the second group form the warp of the sheet-like composite material 10 shown. Of course, the manifold variations known from weaving technology relating to reciprocal running and establishing a weave between weft and warp can also be applied in the solution according to the invention. In particular, it is also possible to use more or fewer elements of the second group arranged in close proximity, for example in order to achieve greater strength in the resulting overall warp if the number of elements 14 mentioned is increased, instead of the arrangements shown in FIG. 1 with sets of three elements 14 of the second group arranged in close proximity. Furthermore, the spacing of two warp threads or elements 14 described as 30 in FIG. 1, i.e. according to the preceding explanation of the spacing between two groups of warp threads, must not be constant throughout the entire sheet-like composite material. There are many different design possibilities here, where desired visual patterns can also be achieved, particularly with large-area composite materials.

Placing of the warp threads, i.e. the elements 14 of the second group, on consecutive elements 12 of the first group also is not limited to the design shown in FIG. 1. As shown in FIG. 1 and starting at the bottommost element 12 of the first group, one element 14 of the second group can run over this element 12 first of all and then under the next element 12 of the first group, then run again over the element 12 of the first group, and so on. Diverging from this pattern, of course, it is also possible for the element 14 of the second group to run under or over one, two or more elements 12 of the second group, regularly or irregularly. This is made possible in particular when the overall warp thread is not formed by individual elements 14, but by several elements 14 of the second group placed close to one another.

FIG. 2A shows a cross-section of the sheet-like composite material 10 according to FIG. 1 through the line marked II-II. The elements 12 of the first group are designed here as square rods 12 with a rectangular, particularly a square cross-sectional shape 34. Furthermore, the elements 14 of the second group form intersections 32 between the elements 12 of the first group disposed at a distance to one another, where each intersection is approximately in the center between neighboring elements 12 of the first group. In FIG. 2A, the elements 12 of the first group are thus arranged vertically. In the square cross-section 34 as shown, the surfaces of elements 12 in the first group that are facing one another are aligned in parallel and this provides the sheet-like composite material with a facility for sound, light, heat, and so on, to pass through it due to the clear width 18 between neighboring elements 12 of the first group as shown in FIG. 1. The points of intersection 32 are approximately in the center of the clear width 18 between two neighboring elements 12 of the first group. In a further embodiment not shown, it is also possible, however, to rotate the elements 12 of the first group with the square cross-section 34, as shown here in FIG. 2A, through 45° round their longitudinal axis so that a rhombus is formed and, in this way, a smaller clear width is obtained between two neighboring elements 12 of the first group, which in turn generates less permeability for sound, light, heat, and so forth.

FIG. 2B shows a cross-section of a further embodiment of the sheet-like composite material 110. Here, the elements 112 of the first group have a rounded, particularly a circular cross-section surface 134 and again, points of intersection 132 of the elements 114 of the second group occur approximately in the center between two neighboring elements 112 of the first group in the region of the clear width 118.

In both FIGS. 2A and 2B, the clear width between two elements of the first group 12 and 112, respectively, is equal to approximately 80 and 150%, respectively, of the span of the elements 12 and 112, respectively, of the first group, in the vertical direction shown in FIGS. 2A and 2B.

FIG. 3 shows a perspective view of a further embodiment of the sheet-like composite material 210, where the elements 212 of the first group have an oval cross-section shape 234. Similar to the manner explained in connection with FIG. 2A and the alternative thereto, where the square rods are rotated through approximately 45° round their longitudinal axis, the solution illustrated in FIG. 3 results in a reduction of the clear width between two neighboring elements 212 of the first group compared to the round cross-sectional shape 134 of the elements 112 of the first group shown in FIG. 2B. The free space above and below an element 212 of the first group in each case up to the points of intersection 232 of the elements 214 of the second group and between the respective element 212 and the point of intersection 232 in each case can be filled better by an element 212 of the first group with oval or elliptical cross-section 234 whose main axis runs vertically, thus a smaller clear width can be obtained between two neighboring elements 212 of the first group.

1. Sheet-like composite material (10) with at least two groups of elements (12, 14), each of which have a larger span in their longitudinal direction (22, 24) than in a direction extending transversely to the longitudinal direction (24, 22), where the elements (12) of a first group are flexurally rigid and are arranged with their longitudinal direction (22) extending across the longitudinal direction (24) of the elements (14) of a second group, and wherein at least some of the elements (12) of the first group have a wooden surface constituting a non-metallic surface, wherein the improvement comprises that the sheet-like composition (10) is embodied as a decorative architectural fabric, in that the elements (12) of the first group form the weft of the sheet-like composite (10), and in that the elements (14) of the second group form the warp of said composite.

2-19. (canceled)

20. Sheet-like composite material (10) comprising: at least two groups of elements (12, 14), each of which have a larger span in their longitudinal direction (22, 24) than in a direction extending transversely to the longitudinal direction (24, 22); wherein the elements (12) of a first group are flexurally rigid and are arranged with their longitudinal direction (22) extending across the longitudinal direction (24) of the elements (14) of a second group; wherein at least some of the elements (12) of the first group are non-metallic and at least some of these non-metallic elements have a wooden surface; wherein the sheet-like composite material (10) is embodied as a visible fabric in which the elements (12) of the first group form the weft of the composite material (10), and the elements (14) of the second group form the warp of the composite material.

21. The composite material (10) according to claim 20, wherein at least two elements (12) of the first group with a non-metallic surface are arranged one beside the other.

22. The composite material according to claim 20, wherein multiple sections of sheet like composite material are arranged one beside the other to form a panel.

23. The composite material (10) according to claim 22, wherein at least some of the elements (12) of the first group have a metallic surface, at least in some sections.

24. The composite material (10) according to claim 22, wherein the composite material comprises a total of n elements (12) of the first group so that at least k elements (12) of the first group having a non-metallic surface are arranged between two further elements (12) of the first group having a metallic surface, at least in some sections, where k is larger than 2 and equal to (n−2).

25. The composite material (10) according to claim 20, wherein at least some of the elements (12) of the first group having a non-metallic surface, consist of a material containing wood fibers.

26. The composite material (10) according to one of claim 20, wherein the elements (12) of the first group that have a wooden surface are made substantially entirely of wood.

27. The composite material (10) according to claim 20, wherein at least some of the elements (12) in the first group are cylindrical, at least over a portion along their longitudinal direction (22).

28. The composite material (10) according to claim 20, wherein at least some of the elements (12) of the first group have a cross-section (34) with a polygonal outer contour, at least over a portion along their longitudinal direction.

29. The composite material (10) according to claim 20, wherein a span width (16) of at least some of the elements (12) of the first group transversely to their longitudinal direction (22) is between 2 and 50 mm.

30. The composite material (10) according to claim 20, wherein a clear width (18) between two neighboring elements (12) of the first group is at least 10% of a span width (16) of the elements (12) of the first group transversely to their longitudinal direction (22).

31. The composite material (10) according to claim 20, wherein a spacing pitch (30) between two neighboring elements (12) of the first group is between 5 and 1,000 mm.

32. The composite material (10) according to claim 20, wherein a spacing pitch 30 between two neighboring elements (14) of the second group is between 3 and 500 mm.

33. The composite material (10) according to claim 20, wherein a span width (26) of at least some of the elements (14) of the second group transversely to their longitudinal direction (24) is between 0.5 and 10 mm.

34. The composite material (10) according to claim 20, wherein at least one of a clear width (18, 28) between two neighboring elements (12) of the first group varies and a clear width between two neighboring elements (14) of the second group varies whereby a haptic effect is produced in the composite material (10).

35. The composite material (10) according to claim 20, wherein at least some of the elements (14) of the second group are flexurally pliable.

36. The composite material (10) according to claim 20, wherein at least some of the elements (14) of the second group are monofilament.

37. The composite material (10) according to claim 20, wherein at least some of the elements (14) of the second group are multifilament.

38. The composite material (10) according to claim 20, wherein at least some of the elements (14) of the second group are made of a metallic material.

39. The composite material according to claim 20, wherein the composite material is a panel on a wall as one of a wall covering or façade decor.

40. The composite material according to claim 20, wherein the composite material is a panel that hangs as one of a sound protection or visual protection.

41. The composite material according to claim 20, wherein the composite material is a security screen.

42. The composite material according to claim 29, wherein the width span is between 5 and 25 mm.

43. The composite material according to claim 30, wherein the clear width is at least 50% of the span width.

44. The composite material according to claim 31, wherein the spacing pitch is between 10 mm and 100 mm.

45. The composite material according to claim 32, wherein the spacing width is between 10 mm and 200 mm.

46. The composite material according to claim 33, wherein the span width is between 1 mm and 5 mm.

47. The composite material according to claim 24, wherein a width span (16) of at least some of the elements (12) of the first group transversely to their longitudinal direction (22) is between 2 and 50 mm;
a clear width (18) between two neighboring elements (12) of the first group is at least 10%;
a spacing pitch (20) between two neighboring elements (12) of the first group is between 5 and 1,000 mm.

48. The composite material according to claim 47, wherein
a spacing pitch 30 between two neighboring elements (14) of the second group is between 3 and 500 mm; and
a span width (26) of at least some of the elements (14) of the second group transversely to their longitudinal direction (24) is between 0.5 and 10 mm.
